(19) United States
(12) Patent Application Publication
(10) Pub. No.: US 2018/0350249 A1
(43) Pub. Date: Dec. 6, 2018

(54) LIVE LEARNING METHOD DEVELOPED FOR VIRTUAL REALITY

(71) Applicant: AMERICAN NATIONAL ELT YAYINCILIK EGTIM VE DANISMANLIK LTD. STI., Antalya (TR)

(72) Inventor: Halil Ç;IL, Antalya (TR)

(21) Appl. No.: 15/612,033

(22) Filed: Jun. 2, 2017

(51) Int. Cl. G09B 5/06; G06F 3/01

(52) U.S. Cl. CPC G09B 5/065; G06F 3/017; G06F 3/012

(57) ABSTRACT

A live learning method is provided for use with virtual reality.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention is a live learning method developed for virtual reality.

### 2. Description of Related Art Including Information Disclosed Under 37 CFR 1.97 and 37 CFR 1.98

Today, there are methods available for providing users with access to prerecorded videos. However, since such videos fail to create the sense of course hours, they are postponed by users who do not attend the video courses. In that case, the efficiency the users get decreases.

The present invention solves such issues. Furthermore, the one-way participation provided in similar applications has been improved in the present invention, allowing for two-way communication and one-on-one dialogue.

### BRIEF SUMMARY OF THE INVENTION

In the present invention, the user puts on VR goggles when it is the course hour, sees and hears the instructor who is not actually in the same room with the user, and they have one-on-one live interaction. The live courses can also be recorded for viewing later. The present invention differs from similar patents in this aspect and also offers the opportunity of watching prerecorded videos with VR goggles.

### DETAILED DESCRIPTION OF THE INVENTION

The present invention is a live learning method developed for virtual reality.

It is a special learning method designed with goggles, a headset, a sensor and software developed by the inventor for the VR goggles.

The user puts on the VR goggles when it is the course hour, sees and hears the instructor who is not actually in the same room with the user, and they have one-on-one live communication. With use of VR goggles in live distance learning field, hand and head movements are provided by the sensor located on the VR goggles and the software compatible with the sensor.

Furthermore, the one-way participation provided in similar applications has been improved in the present invention, allowing for two-way communication and one-on-one dialogue.

### INDUSTRIAL APPLICATION

The present invention is capable of exploitation in industry since it allows an instructor and a learner living in different areas to participate in a course as if they were in the same room and conduct live distance learning activity, which can be prerecorded for further viewing.

I claim:

1. A live learning method developed for virtual reality, characterized in that said method comprises VR goggles, a headset, a sensor and software developed for the VR goggles.

2. A live learning method according to claim 1, characterized in that the user puts on VR goggles when it is the course hour, sees and hears the instructor who is not actually in the same room with the user, and they have one-on-one live interaction.

3. A live learning method according to claim 1, characterized in that, with use of VR goggles in live distance learning field, hand and head movements are provided by the sensor located on the VR goggles and the software compatible with the sensor.

4. A live learning method according to claim 1, characterized in that the live learning activity can be recorded for later viewing.

5. A live learning method according to claim 1, characterized in that the VR goggles, the sensor and the software comprise a completely integrated system, which is programmed in itself without the need to connect to a mobile phone or a computer for the video.

6. A live learning method according to claim 1, characterized in that the instructor and the user hear each other and perceive the movements of one another thanks to the integrated system.

7. A live learning method according to claim 1, characterized in that the integrated system provides the user with a two-way interaction instead of one-way participation and one-one-one dialogue.
